(19) United States
(12) Patent Application Publication
(10) Pub. No.: US 2010/0283974 A1
(43) Pub. Date: Nov. 11, 2010

(54) PROJECTION SYSTEM

(76) Inventors: Fan Wang, Tung Chung (CN); Wai Leung Yeung, Hung Hom (CN)

Correspondence Address: SHEEHAN PHINNEY BASS & GREEN, PA;c/o PETER NIEVES, 1000 ELM STREET, MANCHESTER, NH, 03105-3701, US

(21) Appl. No.: 12/810,891

(22) PCT Filed: Dec. 19, 2008
(86) PCT No.: PCT/CN08/73598

§ 371 Date: Jun. 28, 2010

(30) Foreign Application Priority Data
Dec. 27, 2007 (US) 61/017026

(51) Int. Cl. G03B 31/00; G03B 21/14; G02F 1/1335

(52) U.S. Cl. 353/15; 353/30; 349/8; 353/122; 353/38; 353/52

(57) ABSTRACT

An image projection system has a single reflective light modulator (111), and includes at least one light source (101,103,105). A combiner (107) may be used to combine the light emitted from multiple light sources. A field lens (110) may be placed in conjunction with the reflective light modulator. An optical system (108) may be used to uniformly distribute the light projected on the reflective light modulator and so to be independent of the light intensity distribution of the light source, and/or to change the shape of the light to be projected onto the reflective light modulator. The image projection system may be mounted in a mechanical structure (701,801) having a loudspeaker driver unit (802) installed directly on a surface such that the acoustical and optical waves share the same space. The mechanical structure may be composed of a heat conducting device attached to a heat generating element.

### CROSS-REFERENCE TO RELATED APPLICATIONS

This application claims priority to U.S. provisional patent application US61/017,026, filed on Dec. 27, 2007.

### BACKGROUND OF THE INVENTION

1. Field of the Invention

This invention is related to an image projection system for use in a front projector monitor or a rear projection monitor.

2. Description of the Related Art

Various optical architectures are disclosed in the prior art based on different types of light modulators such as a reflective digital micro-mirror device (DMD), a liquid crystal on silicon (LCOS) device, or transmissive thin film transistor (TFT) based devices. For applications requiring higher light output, three light modulators are used, such that each light modulator is to modulate one of the red, blue, and green colors. In other applications, a single light modulator is used to modulate different colored light at different time instances. It is also possible for a color filter to be coated on the pixels of the single light modulator such that different colored light is modulated spatially.

In recent projection applications such as personal projectors or projectors embedded in mobile devices, compact physical size and high light efficiency are of the essence. For such applications, a projection system using a single reflective light modulator has various advantages over a three-light-modulator-based system or a transmissive-light-modulator-based system, though great care should be taken in the design of such a projection system to achieve both high light efficiency and compactness in size.

### BRIEF SUMMARY OF THE INVENTION

An image projection system of the present invention is based on a single reflective light modulator, and includes a single light source or multiple light sources. Light combining means may be used to combine the light emitted from multiple light sources in a compact and efficient way. A field lens may be placed in conjunction with the reflective light modulator to converge the modulated light, such that a compact and low cost projection lens system is possible. The field lens facilitates compact projection system design for use with portable or embedded applications. Compact enhancement optics may be used to convert the shape of light emitted from the at least one light source, such as a usually concentric shape of the light, to form factor of the active area of the reflective light modulators.

An optical system may be used to uniformly distribute the light projected on the reflective light modulator and so to be independent of the light intensity distribution of the light source, and/or to change the shape of the light to be projected onto the reflective light modulator. Such optical system ensures uniformity of the projected image.

For compactness, the image projection system and its components may be mounted in a mechanical structure having a loudspeaker driver unit installed directly on a surface such that the acoustical and optical waves share at least a portion of the same space. The mechanical structure may be composed of a heat conducting device or material attached to a heat generating element, such that the structure can facilitate dissipating heat from heat generating elements such as the reflective light modulator and the light sources without the need of extra active or passive cooling means, such as cooling fan or cooling pipes with circulating coolant.

### BRIEF DESCRIPTION OF THE SEVERAL VIEWS OF THE DRAWINGS

FIG. 1 shows an example of the projection system of the present invention.

FIG. 2(a) shows an example of the light source with the optical system for collecting light from the light source including reflective means.

FIG. 2(b) shows an example of the light source with the optical system for collecting light from the light source including refractive means.

FIG. 3(a) shows an example of a light combiner optical system.

FIG. 3(b) shows another example of the light combiner optical system such that dichroic surfaces are intersecting with each other at one single axis of interaction.

FIG. 4(a) shows an example if a liquid-crystal-based reflective light modulator is used which modulates light by polarization of the light, in which a polarization means is placed at 45 degrees to the modulator to act both as a pre-polarizer and as a post-polarizer.

FIG. 4(b) shows an example if a liquid-crystal-based reflective light modulator is used which modulates light by polarization of the light, with two polarizer means used respectively as a pre-polarizer and a post-polarizer.

FIG. 5(a) shows the way enhancement optics including one translucent element with two opposite surfaces filled with lens arrays are arranged in two dimensions to operate in a projection system.

FIG. 5(b) shows a three-dimensional view of an example of the enhancement optics including one translucent element with two opposite surfaces filled with lens arrays arranged in two dimensions.

FIG. 5(c) shows the active area of the reflective light modulator.

FIG. 6 shows the way the enhancement optics including a cylindrical lens system operates in a projection system.

FIG. 7 shows an example of the projection system with a mechanical structure including heat conducting means attaching to heat generating elements including a reflective light modulator and a light source.

FIG. 8 shows an example of the projection system with a mechanical structure having a surface with an opening such that a loudspeaker driver unit is attached directly to the surface, such that the acoustical waves and optical waves share some common space.

### DETAILED DESCRIPTION OF THE INVENTION

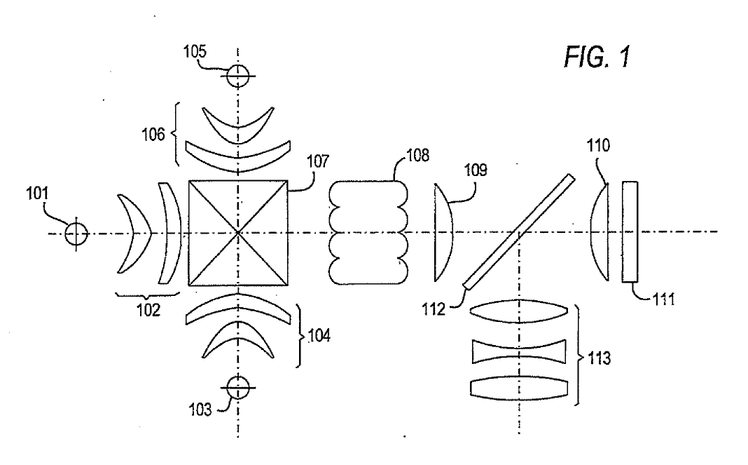

As shown in FIGS. 1-8, various example embodiments of projection systems of the present invention and their components are disclosed.

FIG. 1 shows an example of the projection system disclosed in a first embodiment of the present invention. Light emitted from light sources 101, 103, and 105 passes through respectively light collecting elements 102, 104, and 106. The light combiner means 107 combines the light emitted from the light collecting elements 102, 104, and 106 into a single combined beam of light. The combined light passes through enhancement optics 108 which uniformly distributes the light projected on the reflective light modulator or valve 111, independent of the light intensity distribution of the light source, and/or to change the shape of the light to be projected onto the reflective light modulator 111 matching the form factor of the active area of the reflective light modulator 111. The light then passes through a lens system 109 which serves to change the size of a light spot to match with the subsequent optics and the size of the active area of the reflective light modulator 111. The light coming out of the lens system 109 then passes through a beam splitter system 112 and a field lens system 110. The light is then modulated by the reflective light modulator 111. The modulated and reflected light is redirected by the field lens 110 before reaching the beam splitter system 112. The beam splitter system 112 directs the modulated light to the projection lens system 113 to form a magnified image on a screen.

The example shown in FIG. 1 includes three light sources 101, 103, and 105, typically emitting red, blue, and green light in consecutive time instances. The reflective light modulator 111 modulates in the time instances, such as different colored light according to the image data corresponding to the different colors, to generate a full color image visible to the viewer.

However, depending on the different principles of operations of the projection system, there can be different occasions when the projection system has different numbers of light sources.

In one embodiment, the projection system has only one white light source, such that a full color image is generated by color filter means coated on the reflective light modulator 111. In another embodiment, the projection system has multiple of light sources other than three sources for emitting different colored light in different time instances. One example embodiment is a projection system having red, green, blue, white, and yellow light sources for enhancing system brightness.

In another embodiment, as shown in FIG. 1, the field lens system 110 is placed in conjunction with the reflective light modulator 111 such that the projection lens system 113 can be made compact.

In another embodiment, the reflective light modulator 111 can be (i) a microelectromechanical system (MEMS) such as a digital light processing (DLP) based system, (ii) a reflective Liquid Crystal on Silicon (LCOS), or (iii) a reflective thin-film transistor (TFT) based liquid crystal display.

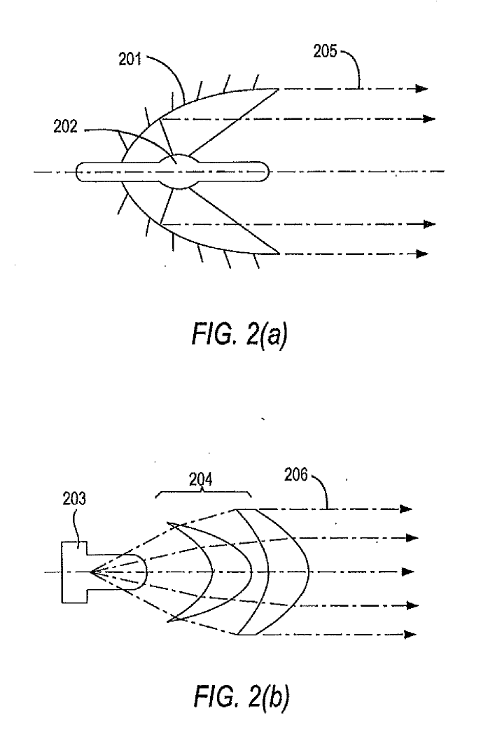

In additional embodiments, the light sources may include (i) a light emitting diode (LED) such as LED 203 in FIG. 2(b), (ii) a surface laser, or (iii) different types of lamps such as the lamp 202 in FIG. 2(a), including Halogen lamps, Xenon lamps, High Intensity Discharge (HID) lamps, Ultra High Pressure (UHP) lamps, and the like.

The optical system to collect the light from each light source includes a combination of refractive and reflective elements. In one embodiment shown in FIG. 2(b) when an LED 203 is used, multiple refractive lens elements 204 are designed to collect the light at the same time to make the light collecting optical system compact. In another embodiment when a short-arc lamp based technology is used, as shown in FIG. 2(a), a reflective optical system 201 is used to collect the light in an efficient manner. There are other instances when both reflective and refractive elements are used for high efficiency collection of light. In some instances the light collecting system is designed to make the collected light substantially collimated, such as the collimated light 205 in FIG. 2(a) and the collimated light 206 in FIG. 2(b), such that the sizes of the subsequent optics can be made compact.

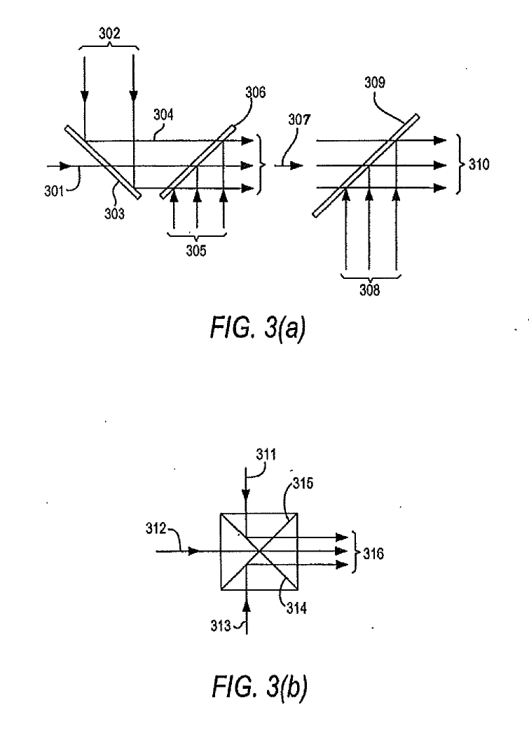

In embodiments when the projection system includes more than one light source, a combiner optical system is used to combine the light from the light sources and to direct the light to follow a single light path. In one embodiment when the projection system includes two light sources, such as the light sources 301 and 302 in FIG. 3(a), the combiner optical system includes one dichroic surface 303 to combine the light to follow a single light path 304, or that in the case of more than two light sources 301, 302, 305, and 308 being present, the combiner optical system includes two or more dichroic surfaces 303, 306, 309, and the like, to combine the light to an intermediate combined light 307 to be applied to the dichroic surface 309 and combined with the light 308 to follow a single light path 310.

A combiner optical system including more than one dichroic surface can also be arranged in such a way that the dichroic surfaces 314 and 315 in FIG. 3(b) intersect with each other at one single axis of intersection, with light sources 311, 312, 313 incident on the dichroic surfaces 314, 315 to form a single light path 316, such that the size of the illumination stage of the projection system can be made compact.

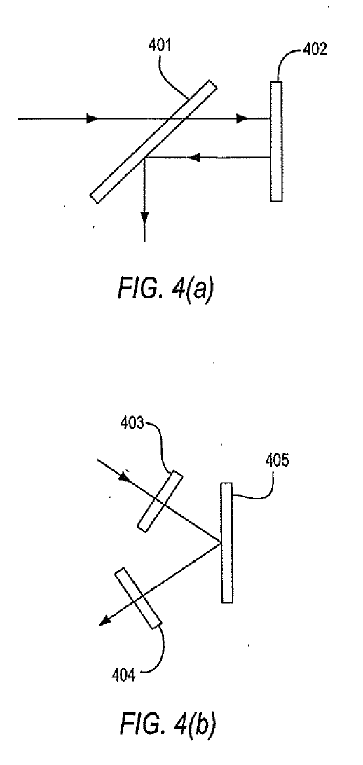

In another embodiment, a beam splitter element 401 in FIG. 4(a) is placed at an angle of 45 degrees to the reflective light modulator 402, which is used when the incident and reflected light are normal to the reflective light modulator. The beam splitter element can be any polarization means such as (i) a sheet polarizer, (ii) a thin film polarizing beam splitter, (iii) a wire-grid polarizer commercially available from “MOXTEK, INC.”, or (iv) a “VIKUITI” polarizing beam splitter commercially available from “3M CORPORATION”.

If a liquid crystal based reflective light modulator 405, as shown in FIG. 4(b), is used to modulate light with certain polarization, such pre-polarization of light before modulation is achieved either by means of a polarized light source such as laser, or by polarization means 403 in FIG. 4(b), such as (i) a sheet polarizer, (ii) a thin film polarizing beam splitter, (iii) a wire-grid polarizer commercially available from “MOXTEK, INC.”, or (iv) a “VIKUITI” polarizing beam splitter commercially available from “3M CORPORATION”, and that post-polarization of light after modulation using a polarization means 404, as shown in FIG. 4(b), is achieved by same or different polarization means such as (i) a sheet polarizer, (ii) a thin film polarizing beam splitter, (iii) a wire-grid polarizer commercially available from “MOXTEK, INC.”, or (iv) a “VIKUITI” polarizing beam splitter commercially available from “3M CORPORATION”.

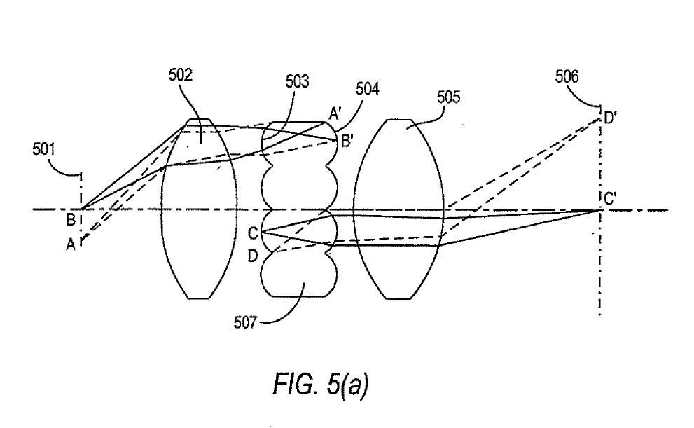

In another embodiment, enhancement optics used in the present invention, such as component 108 in FIG. 1, includes a translucent element 507 in FIG. 5(a) with two opposite surfaces 503 and 504 as shown in FIG. 5(a), filled with lens arrays arranged in two dimensions. In FIG. 5(a), light sources A and B at plane 501 are imaged by the optical system 502, and each of the lenses of the lens array 503, 504 faces the light source to form an image as images A′ and B′ at the corresponding lens of the opposite lens array. Each of the lenses of the lens array facing the light source serves as the aperture of the optical system 502, and the light sources C and D are imaged by the corresponding lens of the opposite lens array and optical system 505 to form an image C′ and D′ at the active area of reflective light modulator 506. By such an arrangement, the distribution of light projected on the reflective light modulator 506 is made uniform and is independent of the light intensity distribution of the light source.

In another embodiment, the opposite lens arrays 503 and 504 are of a similar shape such that the collimated nature of the incident light will be maintained when the collimated light passes through the lens arrays, resulting in relative insensitivity of the position of the translucent optical element 507 against the optical path, and hence the compatibility of the translucent optical element 507 to different optical designs, such as two optical designs: with a combining optical system or light combining means 107 as shown in FIG. 1, and in an alternative embodiment of the components of FIG. 1 but without a combining optical system or light combining means 107.

In another embodiment each of the lenses of the lens arrays 503 and 504 has a form factor or dimensions x and y, shown in FIG. 5(b), matching or similar to a form factor or dimensions of the active area of the reflective light modulator 508, indicated by X and Y in FIG. 5(c), in such a way that x/y=X/Y.

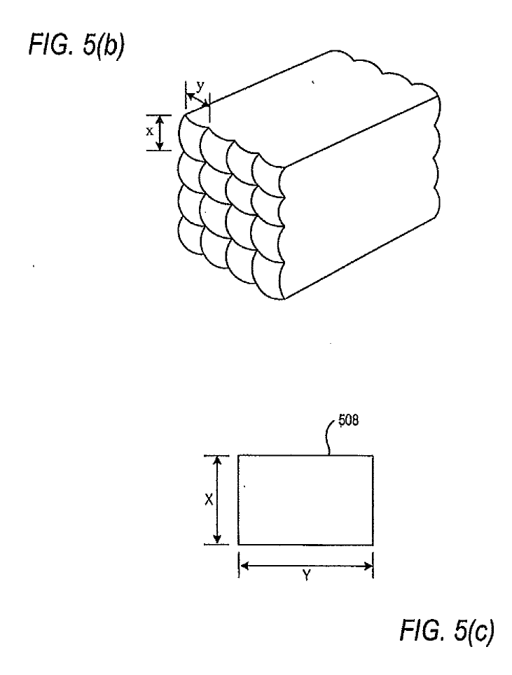

In another embodiment, the enhancement optics includes a cylindrical lens system 601 shown in FIG. 6, designed in such a way to match that of the active area of the reflective light modulator 508 shown in FIG. 5(c).

In yet another embodiment the enhancement optics includes a diffusing means such as a film diffuser. For example, in FIG. 6, a diffuser film 602 is added to the optical system after a lens 601 to uniformly distribute the light projected on the reflective light modulator 603 and is independent of the light intensity distribution of the light source.

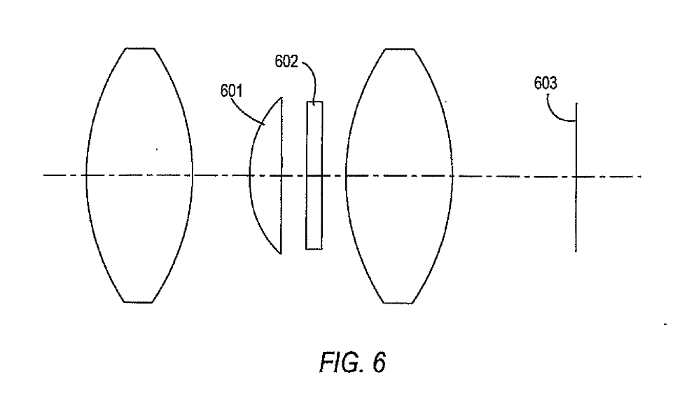

In another embodiment, the projection system of the present invention is mounted on or in a mechanical structure 701, shown in FIG. 7, including heat conducting means attaching thermally to heat generating elements, such as the reflective light modulator 702 in FIG. 7, and/or at least one light sources 703-705 shown in FIG. 7. In this manner, no other forced cooling means such as cooling fan or passive cooling means such as cooling pipes with circulating coolant is needed for compactness of the projection system.

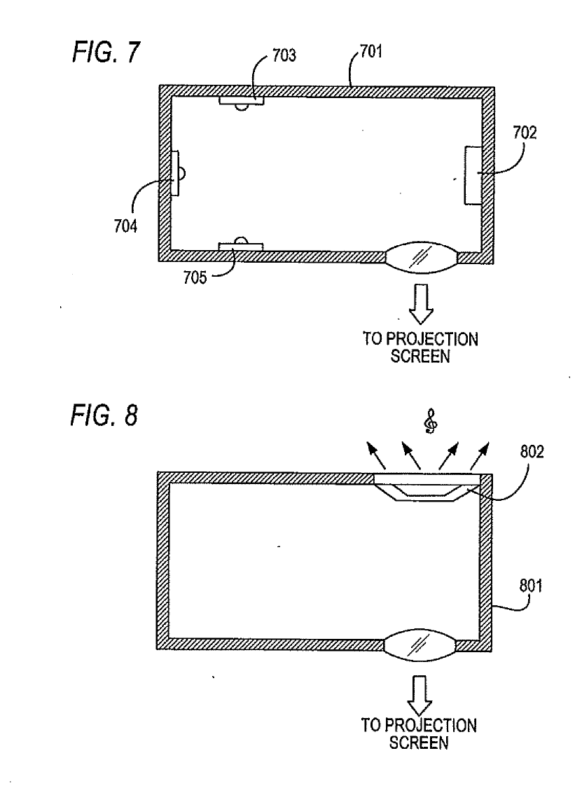

In another embodiment, the projection system of the present invention is mounted on or in a mechanical structure 801, shown in FIG. 8, having at least one surface with at least one opening as well as at least one loudspeaker driver unit 802 in FIG. 8, which is attached directly to the mechanical structure 801 such that the optical and acoustical waves share some common space, resulting in a compact projection system.

1. An image projection system comprising:
(i) at least one light source wherein said light source is a light emitting diode (LED);
(ii) an optical system to collect light from the at least one light source;
(iii) a combiner optical system to direct the light from the light sources to one optical path, if the image projection system includes more than one light source;
(iv) a reflective light modulator;
(v) enhancement optics to uniformly distribute the light projected on the reflective light modulator, independent of the light intensity distribution of the light source, and/or to change the shape of the light to be projected onto the reflective light modulator matching the form factor of the reflective light modulator; and
(vi) a projection lens system.

2. (canceled)

3. The system in claim 1 wherein the optical system to collect light from the at least one light source includes of a combination of refractive and reflective elements

4. The system in claim 1 wherein the optical system includes a lens system including a plurality of refractive elements, such that the light coming out from the optical system is substantially collimated.

5. The system in claim 1 wherein the at least one light source includes a plurality of light sources; and
wherein the combiner optical system includes a plurality of dichroic surfaces, with each dichroic surface for receiving light from a respective one of the plurality of light sources, with the plurality of dichroic surfaces arranged in such a way that the light from the plurality of light sources is redirected to align with each other.

6. The system in claim 5 such that the dichroic surfaces intersect with each other at one single axis of intersection.

7. The system in claim 1 wherein the reflective light modulator is (i) a micro electromechanical system (MEMS), (ii) a reflective Liquid Crystal on Silicon (LCOS), or (iii) a reflective thin-film transistor (TFT) based liquid crystal display.

8. The system in claim 1 wherein the reflective light modulator is a liquid-crystal-based reflective light modulator for modulating light with a predetermined polarization, wherein pre-polarization of light before modulation being achieved by a first polarization means selected from the group consisting of:
(i) a laser;
(ii) a sheet polarizer;
(iii) a thin film polarizing beam splitter;
(iv) a wire-grid polarizer; or
(v) a polarizing beam splitter;
wherein post-polarization of light after modulation is achieved by a second polarization means selected from the group consisting of:
(i) a sheet polarizer;
(ii) a thin film polarizing beam splitter;
(iii) a wire-grid polarizer; or
(iv) a polarizing beam splatter.

9. An image projection system comprising:
(i) at least one light source, wherein said light source is a light emitting diode (LED);
(ii) an optical system to collect light from the at least one light source;
(iii) a reflective light modulator;
(iv) enhancement optics to uniformly distribute the light projected on the reflective light modulator, independent of the light intensity distribution of the light source, and/or to change the shape of the light to be projected onto the reflective light modulator matching the form factor of the reflective light modulator;
(v) a field lens means placed in conjunction with the reflective light modulator; and
(vi) a projection lens system.

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. The system in claim 9, wherein the enhancement optics includes one translucent element with two opposite surfaces filled with lens arrays arranged in two dimensions and the lens arrays on the opposite surfaces are of similar shape and size.

23. (canceled)

24. The system in claim 9 such that the enhancement optics includes a cylindrical lens system with a form factor matching the form factor of the active area of reflective light modulator.

25. The system in claim 9 such that the enhancement optics includes a diffusing means.

26. (canceled)

27. The system as claimed in claim 1 further comprising:
a mechanical structure for mounting the components of the system, with the mechanical structure including at least one surface with at least one surface opening, and with at least one loudspeaker driver unit attached directly to the at least one surface, such that the optical and acoustical waves share a common space.

28. The system as claimed in claim 1 further comprising:
a mechanical structure for mounting the components of the system, with the mechanical structure including:
heat generating elements selected from the group consisting of a relative light modulator and a heating light source; and
heat conducting means thermally coupled to the heat generating elements.

29. The system in claim 28 which does not use active cooling means or passive cooling means.
